(19) United States
(12) Patent Application Publication
(10) Pub. No.: US 2015/0251194 A1
(43) Pub. Date: Sep. 10, 2015

(54) METHOD AND APPARATUS FOR RECOVERING NON-HYDROPHILIC COMPONENTS FROM ALGAE-CONTAINING WATER

(71) Applicant: James Madison Innovations, Inc., Harrisonburg, VA (US)

(72) Inventors: Christopher George Bachmann, Fulks Run, VA (US); Caleb Richard Talbot, Elkton, VA (US)

(21) Appl. No.: 14/632,633

(22) Filed: Feb. 26, 2015

Related U.S. Application Data
(60) Provisional application No. 61/944,893, filed on Feb. 26, 2014.

(51) Int. Cl. B04B 5/10; B04B 5/04; B01D 11/04; C11B 1/02; C10L 1/02

(52) U.S. Cl. CPC B04B 5/10; C11B 1/02; C10L 1/02; B01D 11/048; B04B 5/0442; C10L 2200/0469; C10L 2290/544

(57) ABSTRACT

The present invention relates to a process of recovering non-hydrophilic components from algae-containing water. The process includes providing algae-containing water and a non-polar solvent. The algae-containing water and the non-polar solvent are mixed in a high shear environment under conditions effective to lyse the algae and cause non-hydrophilic components within the algae to be solubilized within the non-polar solvent. The water and the non-polar solvent containing non-hydrophilic components are separated from residual algal biomass. The non-polar solvent containing non-hydrophilic components is recovered. Also disclosed are a system for recovering oil from algae-containing water and a ship including the system of the present invention.

This application claims the benefit of U.S. Provisional Patent Application Ser. No. 61/944,893 filed Feb. 26, 2014, which is hereby incorporated by reference in its entirety.

### FIELD OF THE INVENTION

The present invention relates to a method and apparatus for recovering non-hydrophilic components from algae-containing water.

### BACKGROUND OF THE INVENTION

As the prices of crude oil rise and fall over the years as the course of world events play out, the interest in developing alternatives to fossil fuels, more specifically petroleum fossil fuels, has waxed and waned. Currently, as the price of crude oil continues to rise, so does the interest in its alternatives. The global oil system, like the global coal system prior to the last major energy shift, is suffering from decades of supplier side unrest. While this unrest may or may not be justifiable, this unrest none the less forces reconsideration of the current oil system and focuses efforts on finding the next major energy source to alleviate current supply disruptions and the inequalities that plague the current global energy system.

Reliance on crude oil also creates a number of environmental concerns. The first and most concerning environmental issue related to oil or fossil fuels in general is global climate change. Oil is currently the dominant fossil fuel and a major contributor of anthropogenic CO₂ to the Earth's atmosphere, which may be related to global temperature change. Therefore, drilling for more oil or carbon underground and bringing it to the surface to be released into the atmosphere will only worsen this problem. The other direct environmental problems related to conventional vertical oil drilling are: Noise pollution from drilling, environmental damage from the building of infrastructure around the oil well, the potential for oil spills, presence of industrial communities, disruption of animal migratory paths, accidental animal kills during construction and operation, presence of roads and road construction disrupting the natural ecosystem, spills of other chemicals besides oil, and environmental damage caused by the presence of other supporting infrastructure. In view of the environmental issues related to oil production, as well as other social and economic issues, alternatives to oil have been investigated, including the use of biofuels. Further, as conventional supplies of oil decrease, the necessity of finding other unconventional supplies of or alternatives to oil becomes apparent.

Algae-based biofuels have received increasing attention as an alternative to petroleum products because of their potential to provide clean, renewable energy on a global scale. However, efforts to commercialize algae-based biofuels have failed because they have not been cost-competitive with traditional gasoline and diesel fuels. One of the main challenges in developing a cost-competitive algae-based biofuel is effective separation of algae from the growth medium. The complex hurdle of harvesting is currently in the path of an economically viable, resource abundant, and sustainable algal bio-fuel operation that potentially one day could meet global and domestic energy demand.

The present invention is directed to overcoming these and other deficiencies in the art.

### SUMMARY OF THE INVENTION

One aspect of the present invention relates to a process of recovering non-hydrophilic components from algae-containing water. The process includes providing algae-containing water and a non-polar solvent. The algae-containing water and the non-polar solvent are mixed in a high shear environment under conditions effective to lyse the algae and cause non-hydrophilic components within the algae to be solubilized within the non-polar solvent. The water and the non-polar solvent containing non-hydrophilic components are separated from residual algal biomass. The non-polar solvent containing non-hydrophilic components is recovered.

Another aspect of the present invention relates to a system for recovering oil from algae-containing water including a high-shear mixer; a separation system to: (1) recover an oil/solvent phase from an aqueous phase and (2) recover residual algal biomass; a plurality of storage tanks; a source of a non-polar solvent; and a source of algae-containing water. An input connector couples the source of non-polar solvent and the source of algae-containing water to the high-shear mixer. An output connector couples the high shear mixer to the separation system. A product connector couples the separation system and a first of the plurality of storage tanks to permit discharge of the oil phase into one storage tank and discharge of the residual algal biomass into a second of the plurality of storage tanks.

The method and system of the present invention allow for the recovery, or extraction, of non-hydrophilic components, such as oil, from algae. Specifically, certain types of algae have high lipid content and are single celled organisms that can potentially double on a daily basis under the right growth conditions. Thus, algae can provide a large, renewable source of non-hydrophilic components. Algae are also versatile and (unlike land-based crops such as soy or rapeseed (canola)) can be cultivated in bodies of water, such as the ocean, eliminating land use concerns. Lipids and other non-hydrophilic components extracted from algae may be utilized for a number of applications, including nutritional supplements, pharmaceuticals, pigments, dyes, oils, and antioxidants, by way of example. Oils from algae harvesting may further provide a potential source of biofuel.

### BRIEF DESCRIPTION OF THE DRAWINGS

FIG. 1 is a flowchart of an embodiment of a process for recovering non-hydrophilic components from algae-containing water of the present invention.

FIG. 2 is a block diagram of an embodiment of a system for recovering oil from algae-containing water of the present invention.

FIG. 3 illustrates a partial cross sectional view of a ship containing an embodiment of a system of the present invention.

FIG. 4 is an experimental setup for an emulsification device for harvesting oil from algae.

FIG. 5 is a table of lipid identification results of solvent emulsification lipid extraction of nannochloropsis algae.

### DETAILED DESCRIPTION

The present invention relates to a process of recovering non-hydrophilic components from algae-containing water and a system for recovering oil from algae-containing water. The process and system of the present invention advantageously provide for extraction of non-hydrophilic components, such as lipids, from algae. The non-hydrophilic components may be extracted from normally occurring algae, or algae prepared on a growth medium, which provide an abundant, renewable resource. The extracted non-hydrophilic components may be utilized in a variety of applications, including potential use as a biofuel.

One aspect of the present invention relates to a process of recovering non-hydrophilic components from algae-containing water. The process includes providing algae-containing water and a non-polar solvent. The algae-containing water and the non-polar solvent are mixed in a high shear environment under conditions effective to lyse the algae and cause non-hydrophilic components within the algae to be solubilized within the non-polar solvent. The water and the non-polar solvent containing non-hydrophilic components are separated from residual algal biomass. The non-polar solvent containing non-hydrophilic components is recovered.

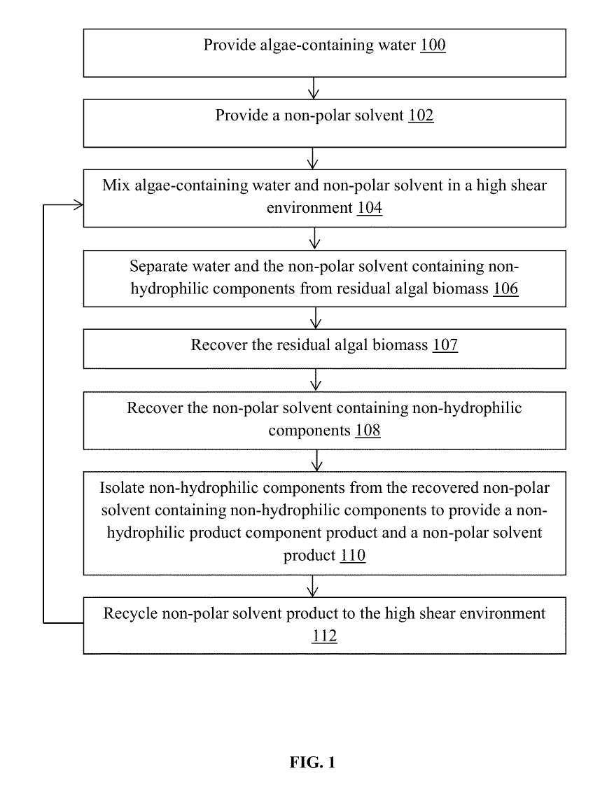

Referring to FIG. 1, an exemplary process for recovering non-hydrophilic components from algae-containing water is described. The process may be carried out in various locations, including on land, at sea, or on a ship, for example. In one embodiment, the process is carried out on a ship to extract non-hydrophilic components from algae-containing water, such as seawater. The ship may be an oil tanker and the recovered non-polar solvent may be stored in the tank of the ship. In other embodiments, the exemplary process may be carried out at sea or on land in facilities having the necessary equipment.

In step 100, algae-containing water is provided for use in the method of the present invention. According to one embodiment, the algae-containing water is seawater extracted from an ocean environment. In another embodiment, algae may be harvested in either an indoor or outdoor algae cultivation system, utilizing an algae cultivation media, such as freshwater, brackish water, seawater, or high-nutrient liquid broths. Nannochloropsis micro-algae, which have high oil content, may be harvested for use in the process, by way of example. Other micro-algae strains such as Botryococcus Braunii, Dunaliella, Chlorela, or other any other algae, including macro-algae or blue-green photosynthetic bacteria and diatoms may also be utilized. In one embodiment, the provided algae-containing water is pre-concentrated using centrifugation to provide a concentrated source of algae. Alternatively, algae-containing water that is not pre-concentrated may be utilized.

In step 102, a non-polar solvent is provided. The non-polar solvent may include, without limitation, alkanes, alkenes, cycloalkanes, pentanes, hexanes, heptanes, octanes, benzenes, toluenes, chloroform, diethyl ether, isopropyl ether, dichloromethane, dioxan, tetrahydrofuran, Napthas, gasoline, and diesel fuels, or blends thereof. Next, in step 104, the algae-containing water provided in step 100 and the non-polar solvent provided in step 102 are mixed in a high shear environment. The high shear environment may be provided by, without limitation, a cavitation device, an ultrasonic device, a mechanical static mixing device, or a mechanical dynamic mixing device. Other devices that provide the necessary high shear environment may be utilized. By way of example, the high shear environment may provide shear forces of at least 1500 dyne/cm². Turbulent mixing and higher fluid stresses may be utilized for faster processing and/or higher levels of oil extraction. Alternatively, the shear forces may be set at the lowest level required to disrupt the membranes of the specific algae being harvested. The algae-containing water and non-polar solvent are mixed in the high shear environment, which provides shear forces to the mixture of algae-containing water and non-polar solvent effective to lyse the algae, i.e., the break the cell wall of the algae to allow for release of non-hydrophilic components from the algae for extraction. The released non-hydrophilic components from the algae are then solubilized within the non-polar solvent. The non-hydrophilic components include components of the algae that are not readily dissolved in water and may include, without limitation, oils (lipids), nutraceuticals, nutritional supplements, or combinations thereof. The mixing in step 104 further results in the creation of residual algal biomass, which constitutes the remainder of the algae after the extraction of the non-hydrophilic components.

In step 106, the water and the non-polar solvent, which now contains the solubilized non-hydrophilic components from the algae, are separated from the residual algal biomass created by the lysing of the algae in step 104. In one embodiment, the components are separated utilizing centrifugation to separate the components based on their respective masses. Alternatively, the water and the non-polar solvent are separated from the residual algal biomass by settling, for example, in a settling tank. In one embodiment, the separated water, which may be seawater or an algae cultivation media, is returned to the ocean or to the algae growth system utilized. Additional purification steps may be performed to obtain additional co-products such as Omega-3 fatty acids, such as DHA, Lutein, or Astaxanthan, which require additional processing to obtain.

In optional step 107, the residual algal biomass obtained as a result of the separation in step 106 is recovered. The recovered residual algal biomass may be directed to a storage tank. The residual biomass contains protein, sugars, and other nutrients, and may be utilized, for example, as animal feed. The residual biomass may be further processed to extract other co-products.

Next, in step 108, the non-polar solvent containing the non-hydrophilic components is recovered after separation in step 106 for further processing. In step 110, the non-hydrophilic components lysed from the algae and solubilized in the non-polar solvent are isolated from the recovered non-polar solvent. The isolation in step 110 results in a non-hydrophilic component and a non-polar solvent product. In one embodiment, the isolation is carried out by distillation of the non-polar solvent containing the solubilized non-hydrophilic components in order to isolate and recover the non-hydrophilic components from the non-polar solvent. The isolation of the non-hydrophilic components from the non-polar solvent may also be performed utilizing flash evaporation and/or chromatography. In step 112, the non-polar solvent product derived in step 110 is optionally recycled back into the system at step 104, where the non-polar solvent is reintroduced to the high-shear environment in combination with additional algae-containing water and the process is repeated. Alternatively, the recovered non-polar solvent may be directed to a storage tank and stored for later usage.

Another aspect present invention relates to a system for recovering oil from algae-containing water including a high-shear mixer, a separation system to: (1) recover an oil/solvent phase from an aqueous phase and (2) recover residual algal biomass, a plurality of storage tanks, a source of a non-polar solvent, and a source of algae-containing water. An input connector couples the source of non-polar solvent and the source of algae-containing water to the high-shear mixer. An output connector couples the high shear mixer to the separation system. A product connector couples the separation system and a first of the plurality of storage tanks to permit discharge of the oil phase into one storage tank and discharge of the residual algal biomass into a second of the plurality of storage tanks.

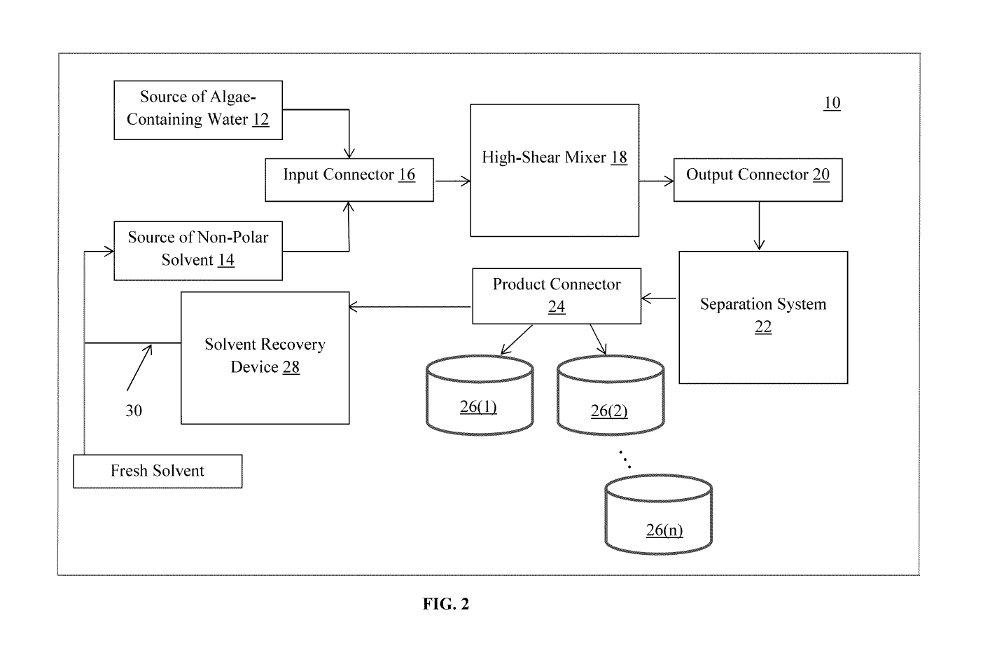

One embodiment of a system for recovering oil from algae-containing water of the present invention is illustrated in FIG. 2. FIG. 2 is a block diagram of system 10 of the present invention that includes source of algae containing water 12, source of a non-polar solvent 14, input connector 16, high-shear mixer 18, output connector 20, separation system 22, product connector 24, plurality of storage tanks 26(1)-26(n), solvent recovery device 28, and recycle line 30. System 10 may include other numbers and types of elements in other combinations. System 10 may be located in various locations on land, at sea, or on a ship, as described further below.

Source of algae containing water 12 provides an input of algae-containing water to system 10. Source of algae-containing water 12 is configured to store and deliver algae-containing water to high-shear mixer 18 through input connector 16. By way of example, source of algae-containing water 12 may be a tank configured to house a supply of algae-containing water and coupled to input connector 16 through a conduit. The algae-containing water may be seawater extracted from an ocean environment, or, alternatively, may be an algae growth media in which algae is harvested in either an indoor or outdoor algae cultivation system. In one embodiment, source of algae-containing water 12 may be linked to and obtain algae-containing water directly from either the ocean or an algae growth system. Alternatively, algae-containing water may be manually transported and inserted into source of algae-containing water 12. In one embodiment the algae is pre-concentrated using a centrifuge, by way of example, prior to insertion into source of algae-containing water 12.

Source of a non-polar solvent 14 provides an input of a non-polar solvent to system 10. Source of non-polar solvent 14 is configured to store and deliver a non-polar solvent to high-shear mixer 18 through input connector 16. By way of example, source of non-polar solvent 14 may be a tank configured to house a supply of non-polar solvent and coupled to input connector 16 through a conduit. The non-polar solvent may include, without limitation alkanes, alkenes, cycloalkanes, pentanes, hexanes, heptanes, octanes, benzenes, toluenes, chloroform, diethyl ether, isopropyl ether, dichloromethane, dioxan, tetrahydrofuran, Napthas, gasoline, and diesel fuels, or blends thereof.

Input connector 16 couples source of algae-containing water 12 and source of non-polar solvent 14 to high-shear mixer 18. Input connector 16 is configured to separately deliver the algae-containing water and the non-polar solvent to high-shear mixer 18 for mixing therein. Input connect 18 may contain any suitable plumbing necessary to deliver the algae-containing water and the non-polar solvent to high-shear mixer 18 for mixing therein, including pipes and valves, by way of example.

High-shear mixer 18 is configured to receive the algae-containing water and the non-polar solvent through input connector 16. High-shear mixer 18 is configured to provide a high-shear environment for mixing of the algae-containing water and the non-polar solvent. High-shear mixer 18 is configured to provide sufficient shear forces to the mixture of algae-containing water and non-polar solvent to lyse the algae to release non-hydrophilic components, such as lipids, from the algae for extraction. After extraction, the released non-hydrophilic components from the algae are solubilized within the non-polar solvent to provide an oil/solvent phase, while the residual water provides an aqueous phase. By way of example, the oil/solvent phase may include lipids and residual biomass. Further, high-shear mixer 18 also creates a residual algal biomass from the remaining algal material after the lysing. In one embodiment, high-shear mixer 18 is a cavitation device. Alternatively, high-shear mixer 18 may be an ultrasonic device, or a mechanical mixing device that provides either static or dynamic mechanical mixing. In one example, high-shear mixer provides shear forces of at least 1500 dynes/cm².

Output connector 20 couples high-shear mixer 18 to separation system 22 and is configured to deliver the mixture of algae-containing water and non-polar solvent created by high-shear mixer 18 to separation system 22. Separation system 22 is configured to: (1) recover an oil/solvent phase from an aqueous phase, and (2) recover algal biomass. More specifically, separation system 22 serves to separate out the residual water (aqueous phase), the non-polar solvent containing the solubilized non-hydrophilic components (oil/solvent phase), and the residual algal biomass created by the lysing of the algae. In one example, separation system 22 is a centrifuge or a centrifugal separator. Alternatively, separation system 22 may be a tank that allows for settling of the different components of the mixture obtained from high-shear mixer 18. In one embodiment, separation system 22 may be coupled to one or more conduits to deliver the residual water (aqueous phase), which may be seawater or algae cultivation media, either to the ocean or to the algae growth system utilized.

Product connector 24 couples separation system 22 to plurality of storage tanks 26(1)-26(n). Product connector 24 permits discharge of the oil/solvent phase recovered by separation system 22 into first storage tank 26(1). Product connector 24 further permits discharge of the recovered residual algal biomass into second storage tank 26(2). It is to be understood that product connector 24 may deliver the separated materials to multiple different storage tanks of the plurality of storage tanks 26(1)-26(n). Plurality of storage tanks 26(1)-26(n) may be any tanks suitable to receive and store the materials delivered from separation system 22.

In one embodiment, solvent recovery device 28 is coupled to separation system 22 and is configured to separate the non-hydrophilic components phase, which have been solubilized in the non-polar solvent, from the non-polar solvent prior to first storage tank 26(1). Solvent recovery device 28 discharges the separated non-hydrophilic components into first storage tank 26(1) for further processing. In one embodiment, solvent recovery device 28 is a distillation column. Alternatively, solvent recovery device 28 may be a flash evaporator. Solvent recovery device 28 also produces a non-polar solvent product separated from the previously solubilized non-hydrophilic components.

In one embodiment, recycle line 30 connects solvent recovery device 28 to source of non-polar solvent 14 and is configured and positioned to carry the separated non-polar solvent product to source of non-polar solvent 14 to recycle the recovered non-polar solvent product back into system 10. Alternatively, recovery line 30 may direct recovered non-polar solvent directly to high-shear mixer 18, or to one of plurality of storage tanks 26(1)-26(n) for later use.

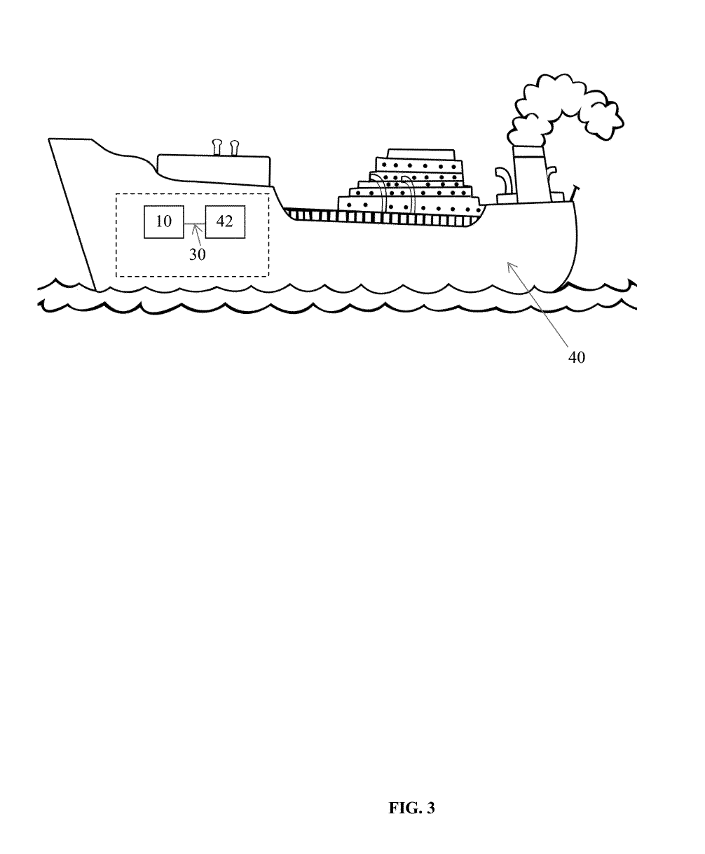

Turning now to FIG. 3, according to one embodiment, system 10 of the present invention is located on ship 40, such as an oil tanker. In this embodiment, source of algae-containing water 12 may draw algae-containing water directly from the environment for input into system 10. Further, recycled sea-water created by separation system 22 may be delivered back to the environment after separation. In this embodiment, the recovered oil may be utilized as a biofuel and delivered to the engine of the ship. System 10 may be located at various locations on ship 40. In one embodiment, system 10 is distributed among different locations to provide greater functionality. In one embodiment, recovered non-polar solvent from solvent recovery device 28 may be stored in tank 42 of ship 40, which is connected to system 10 by recovery line 30.

### EXAMPLES

### Example 1

### Cultivation of Algae on a Harvestable Scale

First, a grow rack was constructed to provide a stable and controlled environment to cultivate algae. The temperature was held constant, the lighting was intense enough, and the conditions of the water were monitored and kept at each algae species' optimal growing conditions. Standard algae cultivation techniques are provided, for example, in Andersen, “Algae Culturing Techniques,” (2005), which is hereby incorporated by reference in its entirety.

Next, algae cultures were inoculated by adding tap water in a similar quantity to the volume of algae medium that would inoculate this new medium to four of the 1 Liter growing vessels and letting them sit overnight to allow the chlorine to evaporate and the water to warm up.

The following day, the required amount of Instant Ocean™ salt mix was prepared to obtain a concentration similar to that of sea water (36 0/00) for two of the vessels. The required amount of salt mix was prepared to obtain a concentration similar to that of brackish water for one of the vessels (4 0/00). For additional algae species, grow vessels were prepared with proper salt concentration and water conditions for those species. The recommended amounts of Kent Pro-culture Parts A & B™ fertilizer solution (10 ml per 20 US Gallon) were added to all of the growth vessels. The growth media of all growth vessels were stirred well.

Generous amounts of each algae strain were added to its respective prepared growth vessel. Nannochloropsis and Dunaliella were inoculated in the seawater vessels, Botryococcus Braunii was to be inoculated in the brackish water vessel and the Chlorella was inoculated in the freshwater vessel. For additional algae species, species were added to the grow vessels prepared for those respective species. Growth vessels were placed on a grow rack to grow to maximum culture. The above procedure was repeated every week to sustain culture growth throughout course of project.

A high intensity grow light system with tanks underneath was constructed to provide a stable and controlled environment to cultivate algae. The temperature was held constant, the lighting was intense enough, and the conditions of the water were monitored and kept at each algae species' optimal growing conditions.

Growth media were prepared and strains were inoculated for high intensity light growth in similar manner as described above. These strains were placed under high intensity lights. It was expected that most of the cells for each strain would not adapt to the high light. Those that did adapt were considered strong and good algae that were then used for outside algae cultivation in direct sunlight once the cultures were expanded to a well-sized volume. All algae were maintained inside during winter.

Production was scaled up to cultures with volumes as large as their containers could hold. Started small and only doubled volume with each culture split, but tried to max out culture capacity (1.5 gallons to 60 gallons if using 60 gallon tank or 250 to 500 gallons if using 250 gallon pools).

Salinity was constantly monitored and full doses of nutrient were added on a regular weekly (optimally 7-10 days between doses) basis. Lights were set to 12 hr on/off cycles and heaters and pumps were used to maintain air circulation and temperature.

Once a stable environment with all the components essential to their survival was provided, algae grew and doubled in population every few days since they were single celled organisms. Mono-cultures were very sensitive and unstable, they needed constant attention for successful cultivation. Regular splitting of cultures was recommended for healthy cultures.

Algae were successfully scaled up from the vials they came in to 1 L beakers, 9 L jars, 30 US gallon tubs, a 60 US gallon aquarium, and finally a 250 US gallon pool.

### Example 2

### Solvent Emulsification Lipid Extraction of Nannochloropsis Algae

### Lipid Extraction Methodology and Results

The salinity of the Nannochloropsis algae culture was measured with the refractometer, and repeated two more times to acquire a total of three samples. This data was obtained to assist with estimating the effect of the salt contained in the growth medium on the remaining measurements.

Using the plastic graduated cylinder, a volume of 16.000 Liters of algae culture was measured out and placed into the wine jar as an inflow of algae. Using one of the glass graduated cylinders, a volume of precisely 0.500 Liter of hexane was measured and placed into the same wine jar as the algae, causing them to enter the emulsification device through the same inflow.

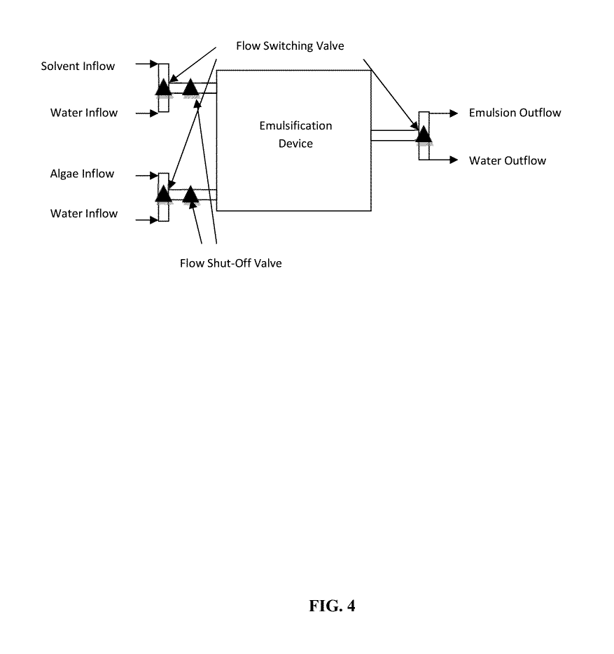

The pump of the emulsification device (as illustrated in FIG. 4) was primed and the entire device's system was allowed to reach steady state by re-circulating the tap water from the five gallon bucket through the device. This required water flowing through both the algae and hexane inflows, as well as the device outflow. The recirculation valve of the device was closed to prevent recirculation, allowing for a one-pass test of the device (externally, the device was set up for multiple passes though).

Once the system reached steady state, both inflow valves were flipped from the 5-gallon bucket of water inflow to the hexane and algae inflows. The hexane inflow was at the top of the wine jar in the hexane layer and the algae inflow was at the bottom of the wine jar in the algae layer. The process outflow was in the bottom of the wine jar as well to allow for maximum hexane exposure. A stopwatch was started immediately at this time. The outflow valve was quickly switched from the five gallon bucket of water to the return hose and then to the wine jar, allowing for recirculation of the product outflow. The valve was then switched back to water after the desired time (˜30 minutes) had passed to allow the algae culture to change color due to pulverization of cells. The pump on the device was shut off after water was successfully re-circulating and the water was changed before conducting any more tests.

The emulsification to separated out into distinctive layers and then de-chlorinated tap water was added to the top of the wine jar to raise the pulverized intermediate layer to the top to be pipetted.

As much sample as possible was collected from the hexane (top) and intermediary “gunk” layers in beaker. The contents of beaker was pipetted into glass centrifuge tubes to be centrifuged.

The glass centrifuge tubes were centrifuged at 5 g for 10 minutes. Three layers formed and 25 mL of the top layer (hexane) was decanted into a clean and pre-weighed glass Petri dish. The hexane was allowed to evaporate and observations were noted. The remaining samples were decanted into separate beakers with a top (hexane) layer beaker, a water and intimidate layer (referred to herein as “gunk”) beaker, and an isopropyl rinse beaker to clean the vials was also used.

The above steps of Example 2 were repeated (except for the Petri dish sampling) over a period of several weeks until the techniques of this process became consistent enough to quantify the inputs and outputs of this process from the emulsification itself to centrifuging.

The top layers (hexane) collected were compiled and evaporated to yield a sample of potential lipids to be sent off for analysis. These layers were initially evaporated off in a beaker and then a glass Petri dish as the sample volume continued to decrease. This sample was then collected into micro-liter centrifuge tubes by using a micro-pipette.

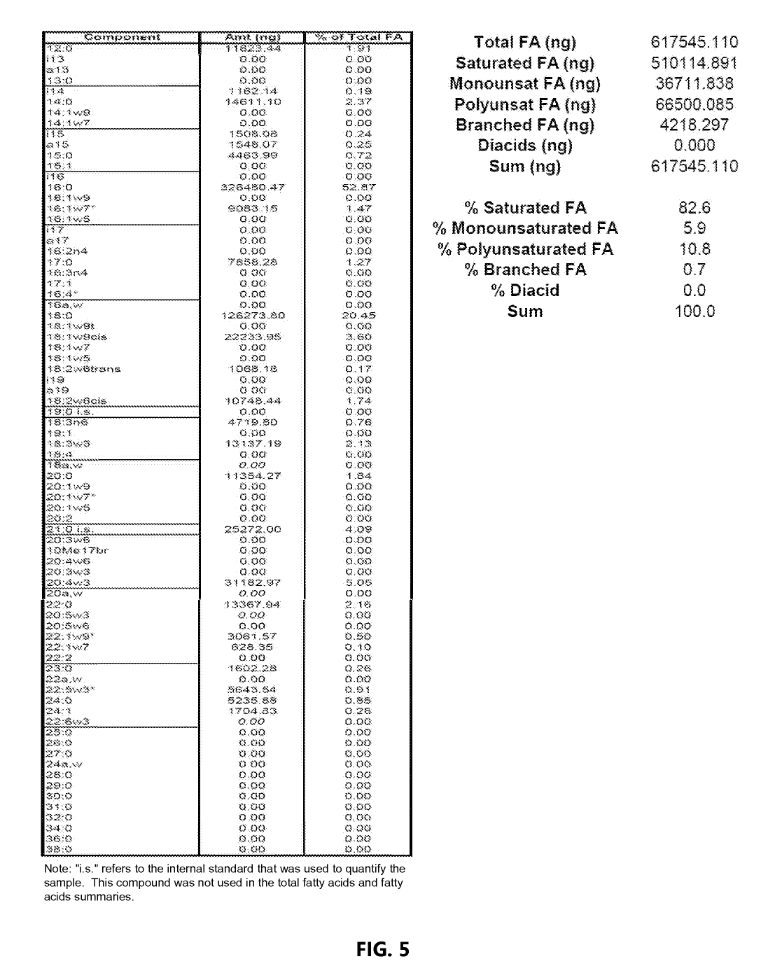

The results from the sample came back positive. The sample was indeed algae lipids with a content 82.6% Saturated fatty acids (“FA”), 5.9% Monounsaturated FA, 10.8% Polyunsaturated FA, and 0.7% Branched FA as illustrated the Table 1 shown in FIG. 5.

### Determining Energy Content of Extracted Oil Using Bomb Calorimeter

The bomb calorimeter was loaded with 200 μL of Nannochloropsis algae lipids by pipetting and set up to conduct bomb calorimetry with input parameters as set forth in Table 2.

TABLE 2
Input Data and Parameters for the Bomb Calorimetry Experiment
Bomb Calorimetry Input Data*

| | |
|---|---|
| Nannochloropsis Lipids Input (μL) | 200 |
| Water Input (mL) | 2000 |
| Fuse Size (cm) | 10 |
| “W” Value (Calories/ΔT)** | 2206.294 |

*Important Data for determining actual energy density of lipids.

The bomb calorimeter had an initial bath temperature of 13.96° C. and final bath temperature of 14.87° C. The bath temperature was below the room temperature for the entirety of the experiment, causing the bath temperature to constantly rise throughout the course of the experiment. This yielded a temperature difference of 0.91° C. that was multiplied by the “W” factor of 2206.294 calories/ΔT to yield an energy output of 2010 calories or 8400 joules. Dividing this value by 200 μL yielded an energy density of 42.0 J/μL or 42.0 MJ/L. The results are shown in Table 3, below.

TABLE 3
Output Data for Bomb Calorimetry Experiment
Bomb Calorimetry Data
Initial Temperature (° C.)*

| | Temperature | | Temperature | | Temperature |
|---|---|---|---|---|---|
| Number | (° C.) | Number | (° C.) | Number | (° C.) |
| 1 | 13.96 | 2 | | 3 | |

*Note that this temperature is below room temperature (~20° C.) and therefore the
temperature will slowly and constantly rise until equilibrium with the room is reached.
Final Temperature Readings (° C.)*

| | Temperature | | Temperature | | Temperature |
|---|---|---|---|---|---|
| Number | (° C.) | Number | (° C.) | Number | (° C.) |
| 1 | 14.53 | 6 | 14.79 | 11 | 14.88 |
| 2 | 14.61 | 7 | 14.81 | 12 | 14.89 |
| 3 | 14.68 | 8 | 14.82 | 13 | 14.90 |
| 4 | 14.76 | 9 | 14.82 | 14 | 14.91 |
| 5 | 14.78 | 10** | 14.87 | 15 | |

*Note that this temperature is below room temperature (~20° C.) and therefore the
temperature will slowly and constantly rise until equilibrium with the room is reached.
**Last major temperature jump occurred here, will use this one as final Temperature value.
Energy Density (J/μL)
42.0
Converting Extracted Algal Oil into Biomass

The volume of oil (1 mL) to be converted was determined by measuring the volume in a micro-pipette. 25% (250 μL) of that volume of methanol was measured out. If the mass of the catalyst is too small to be measured on the scale, a solution is made of a measurable size of the same concentration of KOH to methanol required to perform the reaction. Only the required volume of this solution is taken to perform the reaction.

The mass of Potassium Hydroxide (KOH) (5 mg) required to complete the reaction was weighed on a scale, but used above technique since this amount was too small to be measured on the scale. The required amount of KOH was calculated by converting the ratio of 5 grams KOH per 1000 mL of oil to the volume measured in Step 1 (Note: Isopropanol Titration may help determine the specific catalyst ratio for each individual batch of oil). Air exposure of KOH was limited as much as possible since KOH would absorb water present in the air causing saponification (this is makes soap instead of biodiesel) of the biodiesel. The KOH with methanol were blended by mixing. The methanol with dissolved KOH was then added to the oil that was converted into “bio-diesel.” A beaker containing methanol, KOH, and oil was placed onto a hot plate at roughly 50-60° C. A stirrer bar was placed into the beaker and the hot plate was allowed to heat and vigorously stir the biodiesel reactants for 2 hours.

The biodiesel was removed from the hot plate and set aside overnight. A completed reaction separates out into two layers of methyl-esters (biodiesel) on top and glycerol on bottom. The reaction appeared to work, as evidenced by the reactants changing to the characteristic brown color of a successful reaction.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A process of recovering non-hydrophilic components from algae-containing water, said process comprising:
providing algae-containing water;
providing a non-polar solvent;
mixing the algae-containing water and the non-polar solvent in a high shear environment under conditions effective to lyse the algae and cause non-hydrophilic components within the algae to be solubilized within the non-polar solvent;
separating the water and the non-polar solvent containing non-hydrophilic components from residual algal biomass; and
recovering the non-polar solvent containing non-hydrophilic components.

2. The process of claim 1 further comprising:
isolating non-hydrophilic components from the recovered non-polar solvent containing non-hydrophilic components to produce an non-hydrophilic component product and a non-polar solvent product.

3. The process of claim 2, wherein the non-polar solvent product is recycled to the high shear environment.

4. The process of claim 2, wherein said isolating is carried out by distillation, flash evaporation, and/or chromatography.

5. The process of claim 1, wherein the non-polar solvent is selected from the group consisting of hexanes, pentanes, benzene, toluene, chloroform, ethers, acetone, dimethylformamide, acetonitrile, dimethylsulfoxide, and blends thereof.

6. The process of claim 1, wherein the algae-containing water is seawater or algae cultivation media

7. The process of claim 6, wherein said process is carried out on a ship, at sea, or on land.

8. The process of claim 7, wherein said process is carried out on a ship with the ship being an oil tanker and the recovered non-polar solvent being stored in a tank of the ship.

9. The process of claim 1, wherein the high shear environment is carried out with a device selected from the group consisting of a cavitation device, an ultrasonic device, a mechanical static mixing device, and a mechanical dynamic mixing device.

10. The process of claim 1, wherein said separating is carried out by centrifugation or settling.

11. The process of claim 1, wherein the non-hydrophilic components are selected from the group consisting of oil, nutraceuticals, nutritional supplements, and combinations thereof.

12. The process of claim 1 further comprising:
recovering the residual algal biomass.

13. The process of claim 1 further comprising:
concentrating the algae containing water prior to mixing the algae-containing water and the non-polar solvent in the high shear environment.

14. The process of claim 13 wherein the concentrating is carried out by centrifugation.

15. A system for recovering oil from algae-containing water, said system comprising:
a high-shear mixer;
a separation system to: (1) recover an oil/solvent phase from an aqueous phase and (2) recover residual algal biomass;
a plurality of storage tanks;
a source of non-polar solvent;
a source of algae-containing water;
an input connector coupling said source of non-polar solvent and said source of algae-containing water to said high-shear mixer;
an output connector coupling said high shear mixer and said separation system; and
a product connector coupling said separation system and a first of said storage tanks to permit discharge of the oil phase into one storage tank and discharge of the residual algal biomass into a second of the storage tanks.

16. The system of claim 15 further comprising:
a solvent recovery device coupled to said separation system and capable of separating the non-hydrophilic components phase and the non-polar solvent, said solvent recovery device being configured to discharge the non-hydrophilic components phase into the first of said storage tanks and to produce a non-polar solvent product; and
a recycle line connecting solvent recovery device to the source of non-polar solvent, said recycle line being positioned to carry the non-polar solvent product to said source of non-polar solvent.

17. The system of claim 16, wherein said solvent recovery device is a distillation column or a flash evaporator.

18. The system of claim 16, wherein said high shear mixer is a cavitation device, an ultrasonic device, or mechanical mixing device

19. The system of claim 16, wherein said separation system comprises a centrifuge.

20. A ship comprising the system of claim 15.

21. The ship of claim 20 further comprising:
a solvent recovery device coupled to said separation system and capable of separating the non-hydrophilic components phase and the non-polar solvent, said solvent recovery device being configured to discharge the non-hydrophilic components phase into the storage tank and to produce a non-polar solvent product; and
a recycle line connecting solvent recovery device to the source of non-polar solvent, said recycle line being positioned to carry the non-polar solvent product to said source of non-polar solvent.

22. The ship of claim 20, wherein said solvent recovery device is a distillation column or a flash evaporator.

23. The ship of claim 20, wherein said high shear mixer is a cavitation device, an ultrasonic device, or a mechanical mixing device.

24. The ship of claim 19, wherein said separation system comprises a centrifuge.
